(19) United States
(12) Patent Application Publication
(10) Pub. No.: US 2009/0301962 A1
(43) Pub. Date: Dec. 10, 2009

(54) Filtration housing

(75) Inventors: Paul Priebe, Smithtown, NY (US); Leon Van Wormer, Brentwood, NY (US); Guenter Pradel, Goettingen (DE); Theo Meyer, Holzerode (DE)

Correspondence Address: CASELLA & HESPOS, 274 MADISON AVENUE, NEW YORK, NY, 10016, US

(73) Assignee: Sartorius Stedim Biotech GmbH, Goettingen (DE)

(21) Appl. No.: 12/454,406

(22) Filed: May 18, 2009

(30) Foreign Application Priority Data
Jun. 6, 2008 (DE) 10 2008 027 250.7

(51) Int. Cl. B01D 35/30

(52) U.S. Cl. 210/450

(57) ABSTRACT

A housing (1) for the filtration of liquid media, comprising at least one filter candle (2), which has a fluid-tight transition region (10) of a lower annular end cap (6, 6′) with central outlet (7) to a fluid-permeable outer casing (9) and has a tubular adapter (8, 8′) connected to the end cap (6, 6′), and further comprising a housing top part (3) and a housing bottom part (4) having a housing bottom (5), which latter exhibits at least one cylindrical opening (11) for the reception of the adapter (8, 8′) and separates a non-filtrate chamber (14) surrounding the outer casing (9) of the filter candle (2) from a filtrate chamber (16) connected to the central outlet (7), at least a first seal (18) being provided between the cylindrical opening (11) and the filter candle (2), which seal forms a barrier to the filtrate chamber (16), characterized in that the fluid-tight transition region (10) is received in an end cap receiving region (12) of the cylindrical opening (11) and at least terminates with the base surface (13) of the housing bottom (5), which base surface (13) faces the non-filtrate chamber (14).

### FIELD OF THE INVENTION

The invention relates to a housing for the filtration of liquid media, comprising at least one filter candle, which has a fluid-tight transition region of a lower annular end cap with central outlet to a fluid-permeable outer casing and has a tubular adapter connected to the end cap, and further comprising a housing top part and a housing bottom part having a housing bottom, which latter exhibits at least one cylindrical opening for the reception of the adapter and separates a non-filtrate chamber surrounding the outer casing of the filter candle from a filtrate chamber connected to the central outlet, at least a first seal being provided between the cylindrical opening and the filter candle, which seal forms a barrier to the filtrate chamber.

### PRIOR ART

DE 30 35 938 C1 discloses a multipart filter housing for the pressure filtration of fluids, which has a housing top part and a housing bottom part having a housing bottom which exhibits cylindrical openings for receiving filter candles via the adapters thereof and separates a non-filtrate chamber surrounding the outer casing of the filter candle from a filtrate chamber by which the filter candles are respectively connected to a central outlet. The filter candles here have at their lower end in the vertical direction a fluid-tight annular end cap having a central outlet connected to the tubular adapter by which the filter candle is plugged into the cylindrical opening of the housing bottom. In the non-filtrate chamber is located the filter candle with its fluid-permeable outer casing, the annular end cap forming, with its upper rim facing away from the housing bottom, a fluid-tight transition region to the outer casing.

A drawback with the known, fundamentally established housing for the filtration of liquid media is that the annular end cap is disposed above the housing bottom in the non-filtrate chamber and a residual volume of medium to be filtered is consequently formed between the fluid-tight transition region of the filter candle and the housing bottom, which residual volume, because of the mounted filter or the filter candle, cannot flow away and remains in the housing.

### OBJECT

The object of the present invention is therefore to improve the known housings for the filtration of liquid media such that a residual volume is diminished or, as far as possible, prevented.

### REPRESENTATION OF THE INVENTION

The object is achieved in connection with the preamble to claim 1 by virtue of the fluid-tight transition region being receivable in an end cap receiving region of the cylindrical opening and at least terminating with or lying beneath the base surface of the housing bottom, which base surface faces the non-filtrate chamber.

The fact that the fluid-tight transition region is received in an end cap receiving region of the cylindrical opening makes it feasible to sink or embed the filter candle with its fluid-tight end cap fully into the housing bottom. The fluid-permeable outer casing can thus be used up to the base surface of the housing bottom, so that virtually no residual volume is any longer formed in the non-filtrate chamber.

According to a preferred embodiment of the invention, the first seal is disposed in an upper rim region of the cylindrical opening, said upper rim region lying adjacent to the base surface, and seals the inner circumference of the opening against the outer circumference of the end cap. The first seal thus forms the barrier between the non-filtrate chamber and the filtrate chamber. The filtered medium flows in the usual manner via the central opening of the end cap into the filtrate chamber beneath the housing bottom.

According to a further preferred embodiment of the invention, the seal is disposed in an annular groove of the end cap or is formed onto the end cap.

According to a further preferred embodiment of the invention, a second seal and, where necessary, a third seal is disposed between the adapter and an adjacent region of the cylindrical opening and seals the inner circumference of the opening against the outer circumference of the adapter. Preferably, the second and the third seal are disposed in an annular groove of the adapter. In principle, however, an arrangement in the cylindrical opening is also possible.

According to a further preferred embodiment of the invention, the base surface of the housing bottom exhibits at least one recess, which passes into the cylindrical opening. In order to prevent a residual volume, the fluid-tight transition region is arranged level with the bottom surface of the cylindrical opening.

According to a further preferred embodiment of the invention, the at least one recess is of frustoconical configuration. As a result of the frustoconical configuration, the medium to be filtered is led to the fluid-permeable region of the outer casing.

According to a further preferred embodiment of the invention, the larger diameter of the truncated cone corresponds to the diameter of the housing bottom. The bottom surface of the recess thus corresponds to the base surface of the housing bottom. This is beneficial, in particular, in housings for individual filter candles.

According to a further preferred embodiment of the invention, the cylindrical openings consist of cylinders of different diameters, the respectively smaller cylinder being configured to receive the adapters of the filter candles. The respectively larger cylinder is configured to receive the lower end cap of the filter candle.

According to a further preferred embodiment of the invention, the tubular adapter is welded to the end cap of the filter candle. It is also possible, however, to form the tubular adapter onto the end cap of the filter candle.

Further features of the invention emerge from the following detailed description and the appended drawings, in which preferred embodiments of the invention are illustrated by way of example.

### BRIEF DESCRIPTIONS OF THE DRAWINGS

In the drawings:

FIG. 1: shows a sectional side view of a housing for the filtration of liquid media, comprising two filter candles,

FIG. 2: shows a side view of a housing bottom in section and in cut-out with inserted filter candle and frustoconical recess in the base surface of the housing bottom,

FIG. 3: shows a side view of a further housing bottom in section and in cut-out with cylindrical recess of the housing bottom and inserted filter,

FIG. 4: shows a side view of a further housing bottom in section and in cut-out with an inserted filter candle, in which the end cap and the adapter have an equal-sized outer diameter, and

FIG. 5: shows a sectional side view of a further housing for the filtration of liquid media, comprising a single filter candle.

### DESCRIPTION OF THE ILLUSTRATIVE EMBODIMENTS

A housing 1 for the filtration of liquid media essentially consists of at least one filter candle 2, a housing top part 3 and a housing bottom part 4 having a housing bottom 5. The filter candle 2, which is known per se, has on its vertically lower end an annular end cap 6 having a central outlet 7 which passes into a tubular adapter 8 connected to the end cap 6. The outer casing 9 of the filter candle 2 is fluid-permeable, while the end cap is of fluid-tight configuration. The shell surface of the end cap 6 forms a fluid-tight transition region 10 to the fluid-permeable outer casing 9.

The housing bottom 5 of the housing bottom part 4 has a cylindrical opening 11 for receiving the tubular adapter 8 and an end cap receiving region 12 for receiving the end cap 6 with its fluid-tight transition region 10. That is to say, the filter candle 2 can be plugged with its end cap 6 and tubular adapter 8 into the cylindrical opening 11 such that the fluid-tight transition region 10 terminates with or lies beneath a base surface 13 of the housing bottom 5. The base surface 13 is facing the non-filtrate chamber 14 located between the housing top part 3 and the outer casing 9 of the filter candle. Correspondingly, the underside 15 of the housing bottom 5, which underside faces away from the base surface 13, is facing a filtrate chamber 16 in which the central outlet 7 of the end cap 6 emerges.

The end cap receiving region 12, which forms the upper rim region of the cylindrical opening 11, contains in an annular groove 17 a first seal 18, which is configured, for example, as an annular cord seal. When the filter candle is plugged in, the first seal 18 thus forms a barrier between the non-filtrate chamber 14 and the filtrate chamber 16.

In the region of the tubular adapter 8, in an annular groove 19, there is disposed a second seal 20, and in a parallel annular groove 21 there is disposed a third seal 22. The seals 20, 22 seal the inner circumference of the cylindrical opening 11 against the outer circumference of the tubular adapter 8.

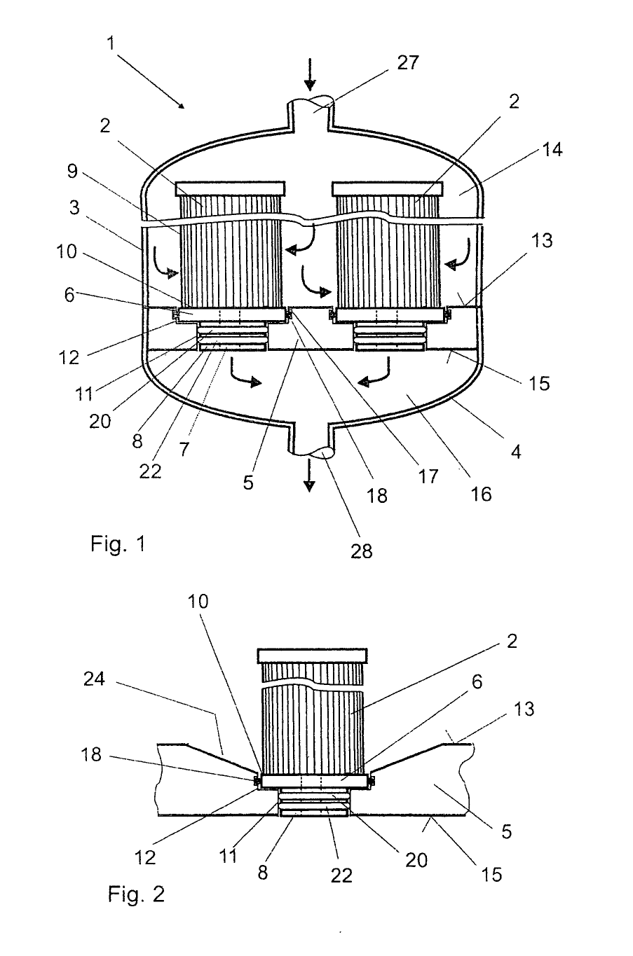

According to the illustrative embodiments of FIGS. 1, 2, 3 and 5, the outer diameter of the end cap 6 is larger than the outer diameter of the tubular adapter 8. The respectively corresponding cylindrical opening 11 is here configured accordingly.

According to the illustrative embodiment of FIG. 4, the outer diameter of the end cap 6′ and the outer diameter of the tubular adapter 8′ are configured equal in size.

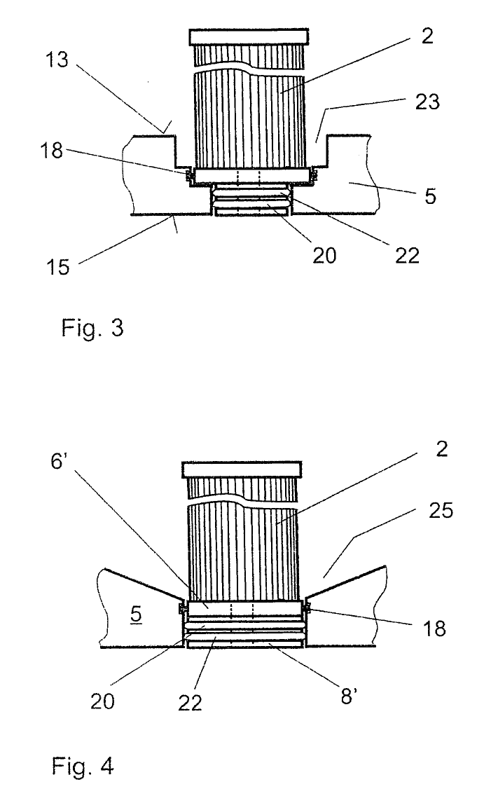

According to the illustrative embodiment of FIG. 3, the base surface 13 of the housing bottom 5 has a recess 23, which passes into the cylindrical opening 11 or the end cap receiving region 12 thereof.

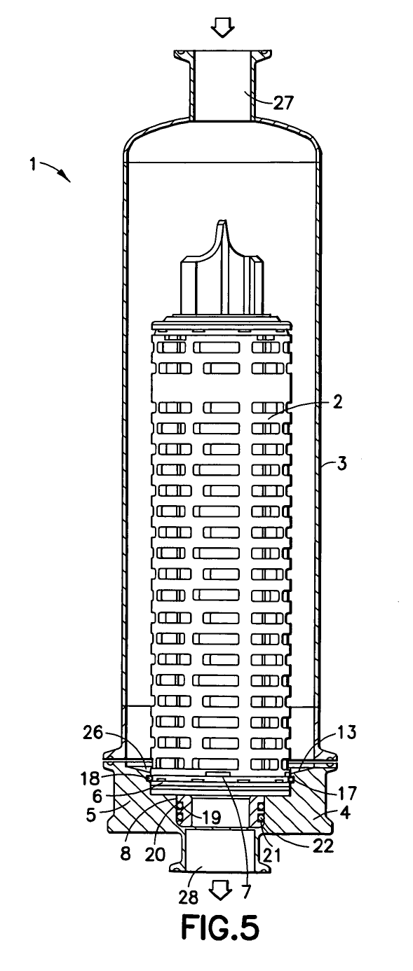

In accordance with the illustrative embodiments of FIGS. 2 and 4, the recess 24, 25 is of frustoconical configuration. According to the illustrative embodiment of FIG. 5, the recess 26 is frustoconically configured such that the larger diameter of the truncated cone substantially corresponds to the diameter of the housing bottom 5, i.e. the housing bottom 5 is configured in the shape of a funnel tapering toward the cylindrical opening 11 or toward the end cap receiving region 12 thereof.

The medium to be filtered is fed via an inflow pipe 27 to the non-filtrate chamber 14 and via the outer casing 9 to the filter candle 2, is filtered, and is fed via the central outlet 7 of the respective filter candle 2 to the filtrate chamber 16 and carried away via an outflow pipe 28 of the housing bottom part 4.

Of course, the embodiments discussed in the specific description and shown in the figures represent merely illustrative embodiments of the present invention. In the light of the disclosure given here, a wide range of variation options are afforded to the person skilled in the art.

1. Housing (1) for the filtration of liquid media, comprising at least one filter candle (2), which has a fluid-tight transition region (10) of a lower annular end cap (6, 6′) with central outlet (7) to a fluid-permeable outer casing (9) and has a tubular adapter (8, 8′) connected to the end cap (6, 6′), and further comprising a housing top part (3) and a housing bottom part (4) having a housing bottom (5), which latter exhibits at least one cylindrical opening (11) for the reception of the adapter (8, 8′) and separates a non-filtrate chamber (14) surrounding the outer casing (9) of the filter candle (2) from a filtrate chamber (16) connected to the central outlet (7), at least a first seal (18) being provided between the cylindrical opening (11) and the filter candle (2), which seal forms a barrier to the filtrate chamber (16),
characterized in that the fluid-tight transition region (10) can be received in an end cap receiving region (12) of the cylindrical opening (11) and at least terminates with or lies beneath the base surface (13) of the housing bottom (5), which base surface (13) faces the non-filtrate chamber (14).

2. Housing according to claim 1, characterized in that the first seal (18) is disposed in an upper rim region of the cylindrical opening (11), said upper rim region lying adjacent to the base surface (13), and seals the inner circumference of the opening (11) against the outer circumference of the end cap (6, 6′).

3. Housing according to claim 1 or 2, characterized in that at least a second seal (20) is disposed between the adapter (8, 8′) and an adjacent region of the cylindrical opening (11) and seals the inner circumference of the opening (11) against the outer circumference of the adapter (8, 8′).

4. Housing according to one of claims 1 to 3, characterized in that the base surface (13) of the housing bottom exhibits at least one recess (23, 24, 25, 26), which merges into the cylindrical opening (11).

5. Housing according to claim 4, characterized in that the at least one recess (24, 25, 26) is of frustoconical configuration.

6. Housing according to claim 5, characterized in that the larger diameter of the truncated cone of the recess (25, 26) corresponds to the diameter of the housing bottom (5).

7. Housing according to one of claims 1 to 6, characterized in that the cylindrical openings (11) consist of cylinders of different diameters and the respectively smaller cylinder is configured to receive the adapters (8, 8′) of the filter candles (2).

8. Housing according to one of claims 1 to 7, characterized in that the tubular adapter (8, 8′) is welded to the end cap (6, 6′) of the filter candle (2).

9. Housing according to one of claims 1 to 8, characterized in that the tubular adapter (8, 8′) is formed onto the end cap (6, 6′) of the filter candle.

10. Housing according to one of claims 1 or 3 to 8, characterized in that the first seal (18) seals the outer circumference of the end cap (6, 6′) against the upper rim region of the cylindrical opening (11) and is disposed in an annular groove of the end cap (6) or is formed onto the end cap (6, 6′).
